(19) United States
(12) Patent Application Publication
(10) Pub. No.: US 2011/0157640 A1
(43) Pub. Date: Jun. 30, 2011

(54) IMAGE FORMING APPARATUS, AND CONTROL METHOD THEREFOR

(75) Inventor: Takayuki Homma, Tokyo (JP)

(73) Assignee: CANON KABUSHIKI KAISHA, Tokyo (JP)

(21) Appl. No.: 12/971,776

(22) Filed: Dec. 17, 2010

(30) Foreign Application Priority Data
Dec. 28, 2009 (JP) 2009-297680

(51) Int. Cl. G06F 3/12

(52) U.S. Cl. 358/1.15

(57) ABSTRACT

An image forming apparatus includes a processing flow execution unit configured to combine a plurality of processes using a plurality of functions included in the image forming apparatus to set the processes as a series of processing flow. If an instruction to execute a part of the processes in the processing flow on trial is received from after a set event occurs and before a waiting time elapses, the processing flow execution unit executes the part of the processes in the processing flow on trial, and executes the processing flow if the waiting time has elapsed without receiving the instruction to execute a part of the processes in the processing flow after the set event occurred.

### BACKGROUND OF THE INVENTION

### 1. Field of the Invention

The present invention relates to an image forming apparatus for automatically executing processes based on an event driven processing flow, a control method therefor, and a program.

2. Description of the Related Art

Image processing apparatuses such as a digital multifunction peripheral and a digital image forming apparatus including a box function for storing image data are known. The box function is a function of storing image data input in various methods such as receiving from a client computer connected via a scanner or a network. A storage location of the image data is referred to as a box. The image data stored in the box is used by an application in a multifunction peripheral in its original form or after being edited. For example, the image data can be used by an application in the multifunction peripheral in a format of being moved to another box in its original form, being bound and printed after being combined with another image data, or being sent via E-mail after being compressed. Use formats of the image data stored in the box include one of combining a plurality of functions and one requiring detailed setting.

On the other hand, a hot folder has been known. The hot folder is a function of automatically printing image data based on a printing attribute previously registered as a folder attribute only by storing the image data in a predetermined folder in an information processing apparatus such as a personal computer (e.g., Japanese Patent Application Laid-Open No. 2005-115660 and Japanese Patent Application Laid-Open No. 2005-242661). Further, by enabling a box to be used as a hot folder, when image data is put into the box, it has been known that a job of the image data can be registered based on a printing attribute registered as a box attribute (folder attribute) (e.g., Japanese Patent Laid-Open No. 2000-118095).

Further, functions other than a printing function included in a multifunction peripheral, for example, E-Mail sending of image data and duplication and movement of image data can also be executed by registering processes other than printing as a box attribute.

If a processing flow in which a series of processes is defined as a rule is associated with an event and registered as an event driven processing flow in a box attribute, the processing flow can also be repeatedly used as a routine work box. This eliminates, when the series of processes is executed, the need to perform detailed setting of each of the processes for each execution and to enable suppression of an operation error and saving of an operation time.

Conventionally, in a multifunction peripheral, a function of starting a previously set series of processes by pressing a predetermined key is implemented (e.g., Japanese Patent Application Laid-Open No. 2000-118095). In order to use the function, however, a user is to press a key. Therefore, the function cannot be used when image data is sent from a driver or an application in a client computer via a network.

This is a difference from a box which can be used as a hot folder. When a plurality of users performs the same work, for example, a particular user such as an administrator sets a hot folder in a particular box, and another general user puts image data into the box to perform work. Thus, efficiency in executing the work by the general user can be improved. Even when a processing procedure is changed, the general user is not aware of the change while the particular user such as an administrator may change setting if the change can be coped with by changing a box attribute. Further, when a limited process that only the particular user is allowed to execute is generated, a function can be simply limited by limiting access to a box in which the limited process is set as a box attribute.

A service processing apparatus which stores an instruction according to a processing flow previously defined and executes, when the instruction is selected, processes according to the processing flow described in the instruction has been discussed (e.g., Japanese Patent Application Laid-Open No. 2004-287859, and Japanese Patent Laid-Open No. 2004-287860).

An image processing apparatus capable of preventing execution of an unintended process due to an erroneous operation and leakage of information by generating and referencing a use history of a hot folder by a user without hampering convenience by using a box as a hot folder has also been discussed (e.g., Japanese Patent Application Laid-Open No. 2008-181237).

In Japanese Patent Application Laid-Open No. 2008-181237, however, a user's intention to use the box is determined based on a use history of the box. The determination is made by only a past use result of the box. When the user stores a new file in the box, therefore, the file is not necessarily processed as intended by the user.

In other words, in the conventional technique, when printing is performed based on an event driven processing flow, it is not found how printing is performed until the printing is actually performed. Therefore, a large amount of a print product unintended by the user may be printed.

### SUMMARY OF THE INVENTION

The present invention is directed to an image forming apparatus that can prevent a processing result of an event driven processing flow from being unintended by a user without damaging advantages of the event driven processing flow.

According to an aspect of the present invention, an image forming apparatus includes a processing flow setting unit configured to combine a plurality of processes using a plurality of functions included in the image forming apparatus to set the processes as a series of processing flow, an event setting unit configured to set an event for driving the processing flow set by the processing flow setting unit, a waiting time setting unit configured to set a waiting time that elapses after the event set by the event setting unit occurred until the processing flow set for the event is executed, a reception unit configured to receive an instruction to execute a part of the processes in the processing flow set for the event on trial, and a processing flow execution unit configured to execute the processing flow, wherein, if the reception unit receives the instruction to execute a part of the processes in the processing flow on trial from after the event set by the event setting unit occurred and before the waiting time elapses, the processing flow execution unit executes a part of the processes in the processing flow on trial, and executes the processing flow if the waiting time has elapsed without the reception unit receiving the instruction to execute a part of the processes in the processing flow after the event set by the event setting unit occurred.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a network configuration to which an image forming apparatus according to first and second exemplary embodiments of the present invention is connected.

FIG. 2 is a block diagram illustrating an example of a hardware configuration of the image forming apparatus.

FIG. 3 illustrates an example of a list screen for an event driven processing flow.

FIG. 4 illustrates an example of a generation screen for an event driven processing flow.

FIG. 5 illustrates an example of a drive event setting screen for an event driven processing flow.

FIG. 6 illustrates an example of an execution function setting screen for an even driven processing flow.

FIG. 7 is a flowchart illustrating processes for executing an event driven processing flow according to the first exemplary embodiment.

FIG. 8 is a flowchart illustrating processes for executing an event driven processing flow by a remote operation according to the second exemplary embodiment.

FIG. 9 is a flowchart subsequent to that in FIG. 8.

FIG. 10 illustrates an example of a processing flow execution history management table.

### DESCRIPTION OF THE EMBODIMENTS

Various exemplary embodiments, features, and aspects of the invention will be described in detail below with reference to the drawings.

### <Image Processing Apparatus (Multifunction Peripheral)>

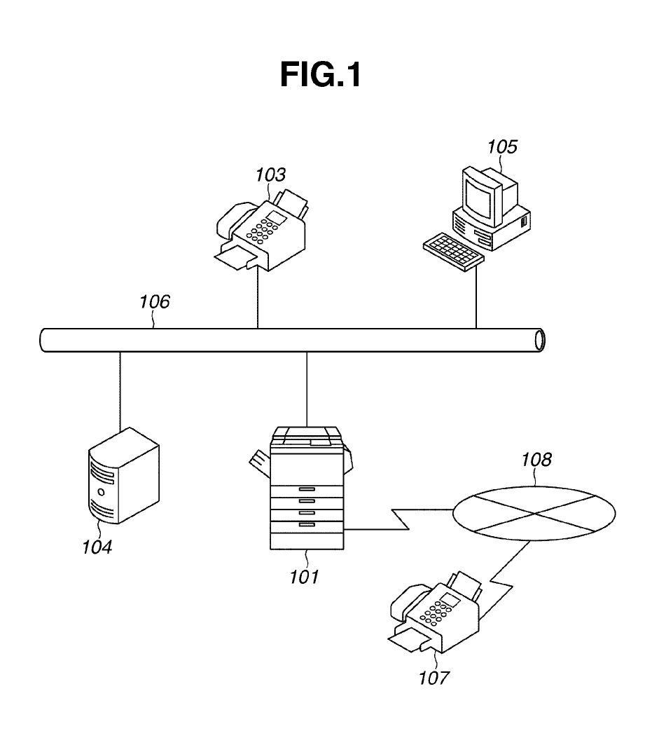

FIG. 1 illustrates a configuration of a network to which an image forming apparatus according to an exemplary embodiment of the present invention is connected. The image forming apparatus illustrated in FIG. 1 is configured as a digital multifunction peripheral (hereinafter referred to as a multifunction peripheral) 101. The multifunction peripheral 101, together with a facsimile apparatus 103, a database/mail server 104, and a client computer (hereinafter referred to as a computer) 105, is connected to a local area network (LAN) 106 including Ethernet (registered trademark) or the like. The multifunction peripheral 101 is connected to a public line 108, together with a facsimile apparatus 107.

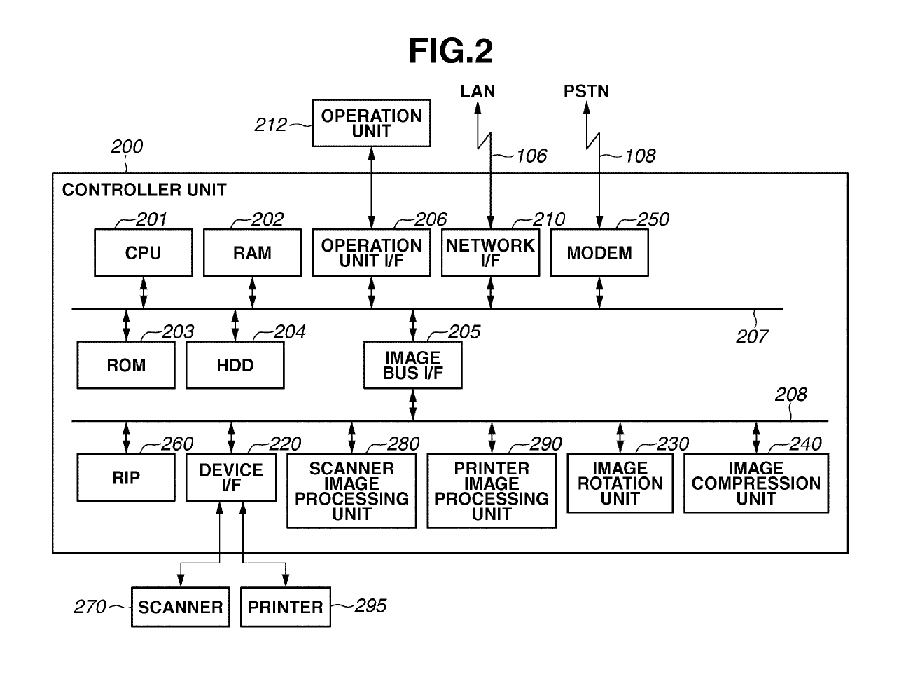

The multifunction peripheral 101 has a scanner function, a copy function, and a facsimile function while having a data sending function for editing image data obtained by the scanner function and sending the edited image data to each of apparatuses on the LAN 106. The multifunction peripheral 101 has an image data storage area referred to as a box in a hard disk drive (HDD) 204 (see FIG. 2). The multifunction peripheral 101 can combine a plurality of pieces of the image data stored in the box into one image data, delete an unnecessary page of the image data, and display the image data in page units. A function of storing the image data in the box is referred to as a box function.

Further, the multifunction peripheral 101 can also move the image data to another box, print the image data, and perform facsimile sending and data sending. The multifunction peripheral 101 has a page description language (PDL) function, and can receive and print PDL image data designated from the computer 105. Further, the multifunction peripheral 101 can store the image data read by the scanner function and the PDL image data designated from the computer 105 in a specified box.

The multifunction peripheral 101 can receive image data from the database/mail server 104 via the computer 105 and the LAN 106, store the image data in the multifunction peripheral 101, and print and output the image data. Further, the multifunction peripheral 101 has a Web server function, and can open a Web site via the LAN 106.

The facsimile apparatus 103 can receive the image data read by the multifunction peripheral 101 via the LAN 106, and sends the received image data as a facsimile to the other apparatuses on the LAN 106. The database/mail server 104 is a server apparatus having functions of receiving the image data read by the multifunction peripheral 101 via the LAN 106, storing the received data as a database, and sending the received data as an electronic mail.

The computer 105 can acquire desired data from the database/mail server 104 and display the acquired desired data. Further, the computer 105 can receive the data read by the multifunction peripheral 101, and process and edit the received data. The computer 105 can make various types of setting of the multifunction peripheral 101 and store the image data in the box of the multifunction peripheral 101 by accessing the Web site opened by the multifunction peripheral 101 via a browser.

The facsimile apparatus 107 can receive the data read by the multifunction peripheral 101 as a facsimile via the public line 108, and can print and output the received facsimile data.

FIG. 2 is a block diagram illustrating a hardware configuration of the multifunction peripheral 101.

The multifunction peripheral 101 includes a controller unit 200. A scanner 270, a printer 295, and an operation unit 212 are connected to the controller unit 200. The controller unit 200 performs control to implement a copy function of causing the printer 295 to print and output image data read by the scanner 270. The controller unit 200 is connected to the LAN 106 and the public line 108 to perform control to input and output image data and device information.

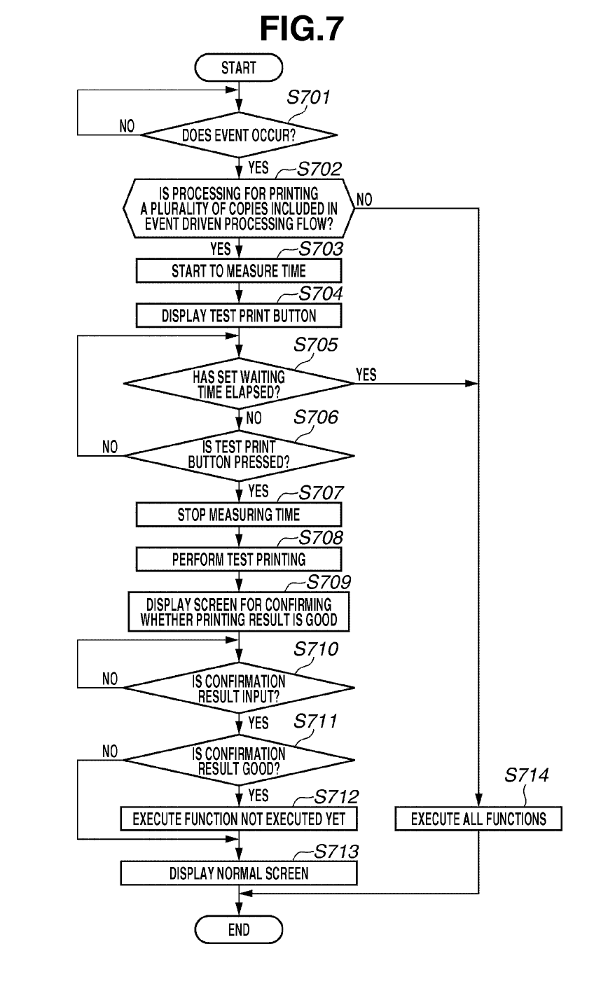

More specifically, the controller unit 200 has a central processing unit (CPU) 201, and the CPU 201 starts an operation system (OS) by a boot program stored in a read-only memory (ROM) 203. The CPU 201 executes an application program (including one corresponding to FIGS. 7 to 9) stored in the HDD 204 on the OS, thereby executing various types of processing. A random access memory (RAM) 202 is used as a work area of the CPU 201. The RAM 202 is used as the work area, and is also used as an image memory area for temporarily storing image data. The HDD 204 is used to store the application program and the image data.

A plurality of storage areas (boxes) for storing image data is formed in the HDD 204. At least one of the plurality of boxes in the HDD 204 functions as a hot folder, and can drive an event driven processing flow by generating an event to store image data in the box, as described below.

An operation unit interface (I/F) 206, a network I/F 210, a modem 250, and an image bus I/F 205 are connected to the CPU 201 via a system bus 207 together with the ROM 203, the RAM 202, and the HDD 204.

The operation unit I/F 206 is an interface with the operation unit 212 including a touch panel, and outputs to the operation unit 212 image data to be displayed on the operation unit 212. The operation unit I/F 206 causes the operation unit 212 to send out data and a command which are input by a user to the CPU 201.

The network I/F 210 is connected to the LAN 106, and inputs and outputs data and a command to and from each of the apparatuses on the LAN 106 via the LAN 106. The modem 250 is connected to the public line 108, and inputs and outputs the data and the command via the public line 108.

The image bus I/F 205 is a bus bridge for connecting the system bus 207 and an image bus 208 for transferring image data at high speed and converting a data format. A raster image processor (RIP) 260, a device I/F 220, a scanner image processing unit 280, a printer image processing unit 290, an image rotation unit 230, and an image compression unit 240 are connected to the image bus 208.

The RIP 260 is a processor for rasterizing a PDL code into a bit map image. The device I/F 220 is connected to the scanner 270 and the printer 295 to convert image data. The scanner image processing unit 280 corrects, processes, and edits the input image data. The printer image processing unit 290 subjects the print output image data to correction and resolution conversion corresponding to the printer 295. The image rotation unit 230 rotates image data. The image compression unit 240 compresses multi-level image data into Joint Photographic Experts Group (JPEG) data and binary image data into Joint Bi-level Image Experts Group (JBIG), Modified Modified Relative Element Address Designate (MMR), and Modified Huffman (MH) data. The image compression unit 240 also expands the compressed data.

### <Example of Event Driven Processing Flow>

Processes relating to a plurality of functions of the multifunction peripheral 101 are optionally combined into a series of processing flow (also referred to as “work flow”). An event driven processing flow corresponding to an event for driving the series of processing flow (drive event) is set, as described below, for example. It is assumed that, “store image data: Box 10” is set as a drive event, and as functions (processes) to be executed, “trigger image data” is set in an input function “box” and “staple, 50 copies” is set in an output function “print”. In the event driven processing flow, when image data is stored in Box 10, the image data put in Box 10 is automatically printed (the number of print copies: 50, stapling process: Yes).

### <Description of Event Driven Processing Flow>

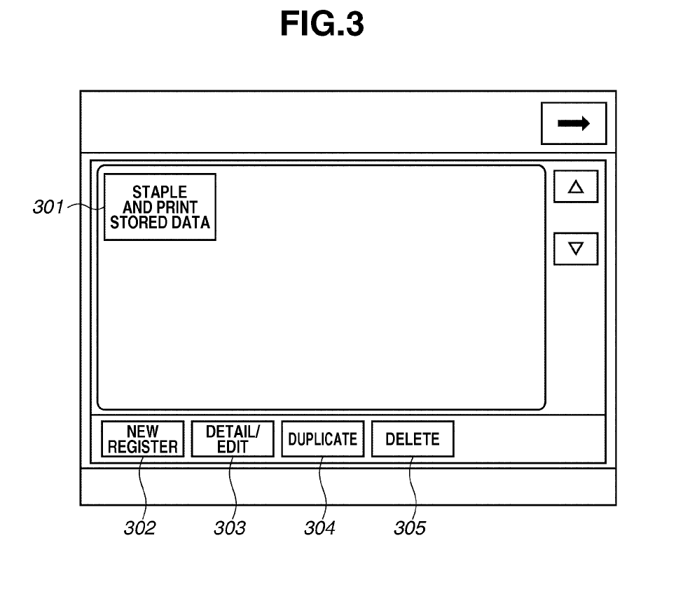

Generation of an event driven processing flow will be described below with reference to FIGS. 3 to 6. FIGS. 3 to 6 are examples of operation screens (user interface) displayed on the touch panel of the operation unit 212 by the CPU 201 via the operation unit I/F 206, and keys on the operation screens are software keys.

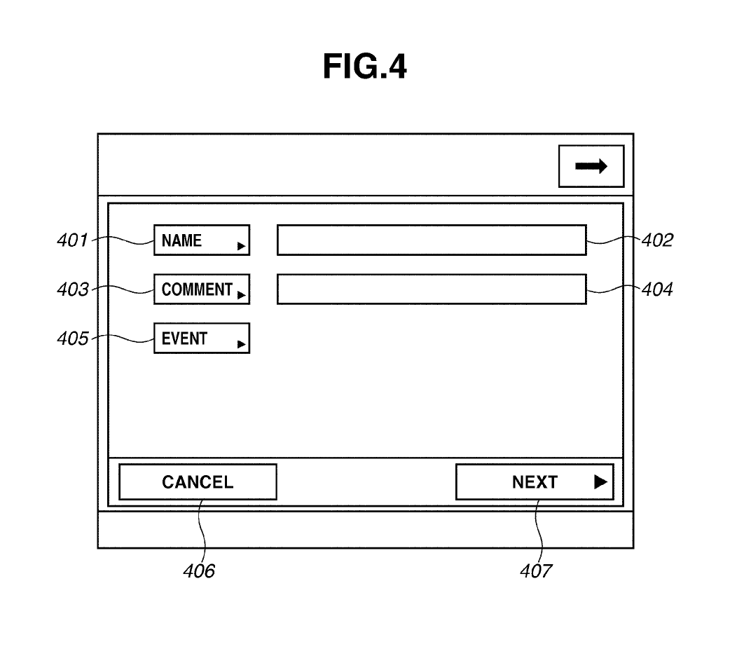

FIG. 3 illustrates an example of an event driven processing flow list screen. In FIG. 3, in a field 301, the event driven processing flow is individually displayed in a button format. When a new register key 302 is pressed, the screen is shifted to an event driven processing flow generation screen illustrated in FIG. 4.

When a detail/edit key 303 is pressed, the screen is shifted to an operation screen (not illustrated) for confirming and changing setting of the event driven processing flow which is being selected in the field 301. When a duplicate key 304 is pressed, the event driven processing flow which is being selected in the field 301 is duplicated. When a delete key 305 is pressed, the event driven processing flow which is being selected in the field 301 is deleted.

FIG. 4 illustrates an example of the event driven processing flow generation screen. In FIG. 4, when a name key 401 is pressed, an event driven processing flow name input screen (not illustrated) is displayed, and a name of an event driven processing flow to be generated can be set. When the name of the event driven processing flow is set on the name input screen, the name is displayed on a name field 402 of the event driven processing flow generation screen illustrated in FIG. 4.

When a comment key 403 is pressed, a comment input screen (not illustrated) is displayed. On the comment input screen, a comment corresponding to the event driven processing flow to be generated can be set. The comment set on the comment input screen is displayed in a comment field 404 of the event driven processing flow generation screen illustrated in FIG. 4.

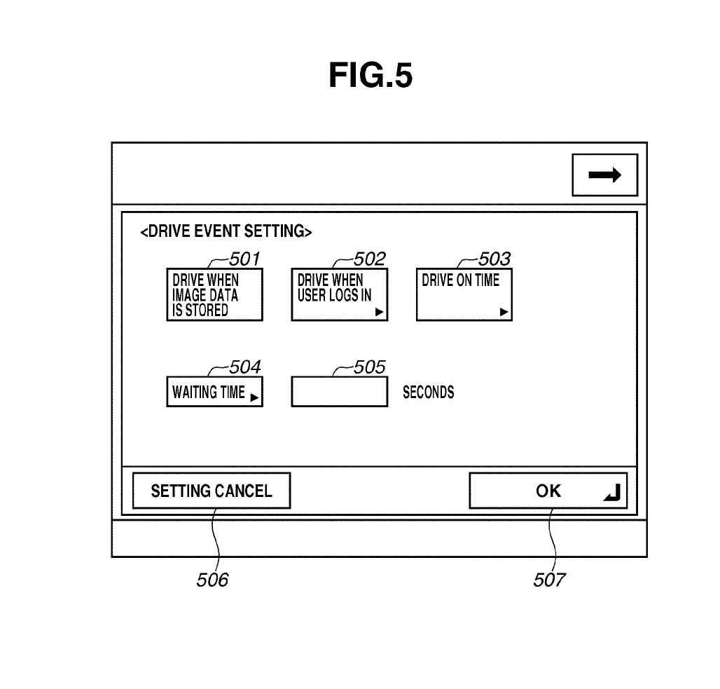

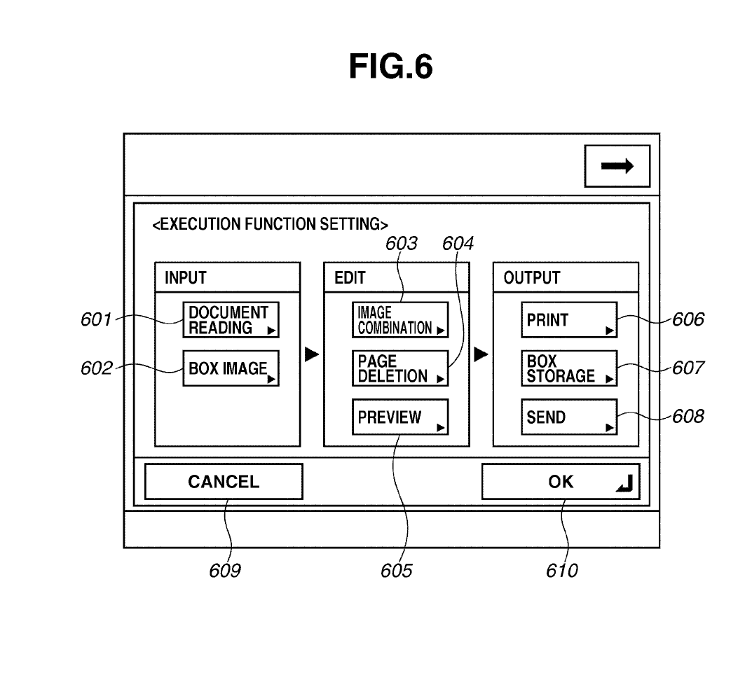

When an event key 405 is pressed, the screen is shifted to a drive event setting screen illustrated in FIG. 5. When a cancel key 406 is pressed, the screen is shifted to the event driven processing flow list screen illustrated in FIG. 3. When a next key 407 is pressed, the screen is shifted to an event driven processing flow execution function setting screen illustrated in FIG. 6.

When a “drive when image data is stored” key 501 is pressed on the drive event setting screen illustrated in FIG. 5, a box selection screen (not illustrated) is displayed. On the box selection screen, setting can be made to drive the event driven processing flow when the image data is stored in the box selected on the screen.

If a “drive when a user logs in” key 502 is pressed, a user setting screen (not illustrated) is displayed. On the user setting screen, setting can be made to drive the event driven processing flow only if a designated user logs in. When a “drive on time” key 503 is pressed, a time setting screen (not illustrated) is displayed. On the time setting screen, setting can be made to drive the event driven processing flow when a time set on this screen has elapsed. As a drive event for driving the event driven processing flow, a drive event other than the above described three drive events can also be set. For example, a processing flow may be driven in response to an instruction from the user. In this case, “an instruction from a user” is set as an event.

When a waiting time key 504 is pressed, a waiting time setting screen (not illustrated) is displayed. On the waiting time setting screen, an execution waiting time from generation of the drive event for driving the event driven processing flow until the event driven processing flow is actually executed can be set. The execution waiting time set on the waiting time setting screen is displayed on an execution waiting time field 505.

When a setting cancel key 506 is pressed, all the settings made on the drive event setting screen are canceled and the screen is shifted to the event driven processing flow generation screen illustrated in FIG. 4. When an OK key 507 is pressed, the settings made on the drive event setting screen are stored and the screen is shifted to the event driven processing flow generation screen illustrated in FIG. 4.

On the event driven processing flow execution function setting screen illustrated in FIG. 6, setting for sequentially executing three types of processes, i.e., image input, image edit, and image output can be made. When a document reading key 601 is pressed, a document reading setting screen (not illustrated) is displayed. On the document reading setting screen, setting for reading a document can be made. When a box image key 602 is pressed, a box image data selection screen (not illustrated) is displayed. On the box image data selection screen, box image data stored in a box can be designated. On the box image data selection screen, image data to be a trigger for driving the event driven processing flow can also be designated.

When an image combination key 603 is pressed, an image data combination setting screen (not illustrated) is displayed. On the image data combination setting screen, setting can be made to combine a plurality of pieces of the image data into one image data. When a page deletion key 604 is pressed, a page deletion setting screen (not illustrated) is displayed. On the page deletion setting screen, setting can be made to delete an unnecessary page in the image data which is being processed. When a preview key 605 is pressed, a preview setting screen (not illustrated) is displayed. On the preview setting screen, setting can be made to preview the image data which is being processed before outputting the image data.

When a print key 606 is pressed, a print setting screen (not illustrated) is displayed. On the print setting screen, setting can be made to print the image data which is being processed. When a box storage key 607 is pressed, a box storage setting screen (not illustrated) is displayed. On the box storage setting screen, setting can be made to store the image data which is being processed in a box. When a send key 608 is pressed, a sending setting screen (not illustrated) is displayed. On the sending setting screen, setting can be made to send the image data which is being processed.

When a cancel key 609 is pressed, the settings made on the event driven processing flow execution function setting screen are canceled and the screen is shifted to the event driven processing flow generation screen illustrated in FIG. 4. When an OK key 610 is pressed, the event driven processing flow is generated in a format of driving an event based on the settings made on the event driven processing flow execution function setting screen and the screen is shifted to the event driven processing flow list screen illustrated in FIG. 3. <Description of Execution of Event Driven Processing Flow>

Processes for executing an event driven processing flow in the first exemplary embodiment will be described below with reference to a flowchart in FIG. 7.

The execution processes are performed by the CPU 201 according to an application program stored in the ROM 203 or the HDD 204 in the multifunction peripheral 101.

When the multifunction peripheral 101 is started and the application program according to the flowchart illustrated in FIG. 7 is started, the processing proceeds to step S701. In step S701, the CPU 201 starts a task for each event driven processing flow set as a drive event to monitor whether an event occurs. If the event set as the drive event occurs (YES instep S701), the processing proceeds to step S702. In step S702, the CPU 201 determines whether the event driven processing flow relating to the event includes a process for printing a plurality of copies.

If the process for printing a plurality of copies is not included (NO in step S702), the processing proceeds to step S714. In step S714, the CPU 201 executes the event driven processing flow for the event that has occurred. Then the process for executing the current event driven processing flow end.

On the other hand, if the process for printing a plurality of copies is included (YES in step S702), the processing proceeds to step S703. In step S703, the CPU 201 starts to measure time for monitoring whether an execution waiting time set in the event driven processing flow elapses. In step S704, the CPU 201 then displays a trial print button display screen (not illustrated) on the touch panel of the operation unit 212. In step S705, the CPU 201 then determines whether the execution waiting time set in the event driven processing flow has elapsed. If the execution waiting time has elapsed (YES in step S705), the processing proceeds to step S714. In step S714, the CPU 201 executes all functions (processes) set as the event driven processing flow for the event that has occurred.

If the execution waiting time has not elapsed yet (NO in step S705), the processing proceeds to step S706. In step S706, the CPU 201 determines whether a user presses the trial print button. If the trial print button is not pressed (No in step S706), the processing returns to step S705. If the trial print button is pressed (YES in step S706), the processing proceeds to step S707. In step S707, the CPU 201 stops measuring time for monitoring whether the execution waiting time set in the event driven processing flow elapses.

In step S708, the CPU 201 performs trial printing serving as a printing function after executing an input function and an editing function, which are set as the event driven processing flow for the event that has occurred. The trial printing means printing only the first copy of a print product before printing the plurality of copies after setting stapling, layout printing, two-sided printing, or the like. The user can confirm an output copy of the print product to confirm whether there is no error in the print setting. More specifically, in step S708, the CPU 201 executes a part of the processes in the series of processing flow to enable the user to confirm whether an intended print product is obtained by automatic print processing based on the event driven processing flow.

In step S709, the CPU 201 then displays on the touch panel of the operation unit 212 an operation screen for the user to confirm whether the copy of the print product obtained as a result of performing the trial printing is “good”. In step S710, the CPU 201 determines whether a confirmation result about the copy of the print product obtained by the trial printing is input from the operation screen. If the confirmation result is input (YES in step S710), the processing proceeds to step S711. In step S711, the CPU 201 determines whether the confirmation result is “good”. If the confirmation result is “good” (YES in step S711), the processing proceeds to step S712. In step S712, the CPU 201 prints the remaining copies and executes a box function, a sending function, or the like for the other set box. In step S713, the CPU 201 then releases display of the trial print button, and displays a normal screen (initial screen) of the multifunction peripheral 101 on the touch panel of the operation unit 212. The processes for executing the current event driven processing flow end.

If the confirmation result of the copy of the print product obtained by the trial printing is not “good” (NO in step S711), the processing proceeds to step S713. In step S713, the CPU 201 displays the normal screen of the multifunction peripheral 101 on the touch panel of the operation unit 212 without performing the execution process in step S712.

In the first exemplary embodiment, the trial printing can be performed during the execution waiting time that elapses until the event driven processing flow is actually executed. When the execution waiting time has elapsed, the event driven processing flow can be actually executed.

Accordingly, the print product unintended by the user can be prevented from being printed in large amounts without damaging an advantage of the event driven processing flow. In other words, in first exemplary embodiment, production of a processing result unintended by the user can be suppressed without damaging the advantage of the event driven processing flow by partially executing the functions in the event driven processing flow as a trial. Further, convenience for a user who has combined the event driven processing flow and the box and used the combination as a hot folder is not impaired.

In step S704 in the flowchart illustrated in FIG. 7, a normal processing flow execution button may be displayed together with the trial print button. In this case, if the CPU 201 detects that the user presses the normal processing flow execution button, the processing proceeds to step S714. Instep S714, the CPU 201 executes the process described in the event driven processing flow.

A user can remotely store image data in a box formed in the HDD 204 in the multifunction peripheral 101 by accessing a Web site in the multifunction peripheral 101 via a browser with the computer 105.

In a second exemplary embodiment, the computer 105 executes an event driven processing flow when the image data is remotely stored in the box of the multifunction peripheral 101. Also in the second exemplary embodiment, it is assumed that, “store image data: Box 10” is set as an event, and as functions to be executed, “trigger image data” is set in an input function “box” and “staple, 50 copies” is set in an output function “print” as similar to the first exemplary embodiment.

When image data is stored in the box of the multifunction peripheral 101 from the computer 105, a user performs work with the computer 105 spaced apart from the multifunction peripheral 101. Therefore, a process relating to confirmation of performance of trial printing differs from that in the first exemplary embodiment.

### <Description of Execution of Event Driven Processing Flow by Remote Operation>

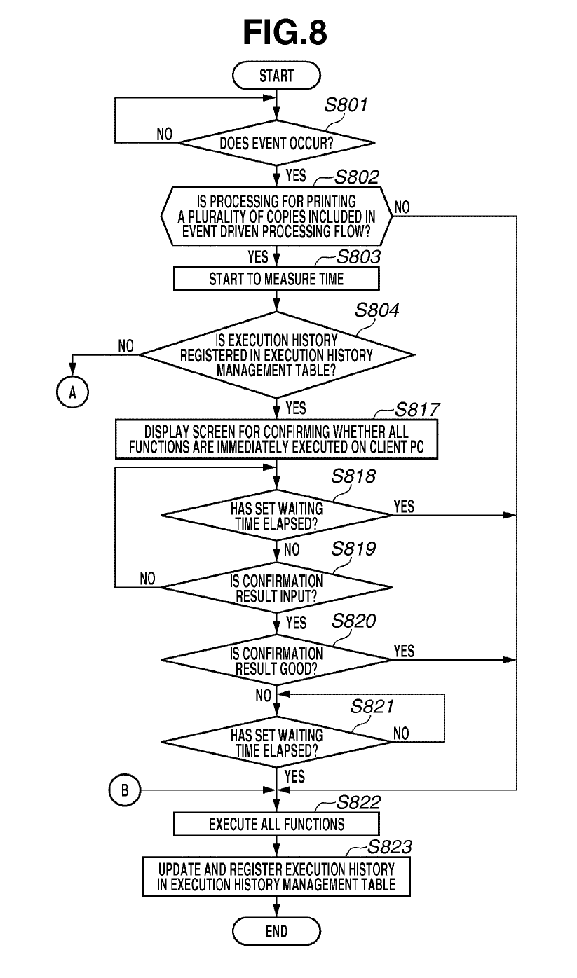

Processes for executing an event driven processing flow by a remote operation in the second exemplary embodiment will be described below with reference to FIGS. 8 to 10. The execution processes are performed by the CPU 201 according to an event driven application program stored in the ROM 203 or the HDD 204 in the multifunction peripheral 101.

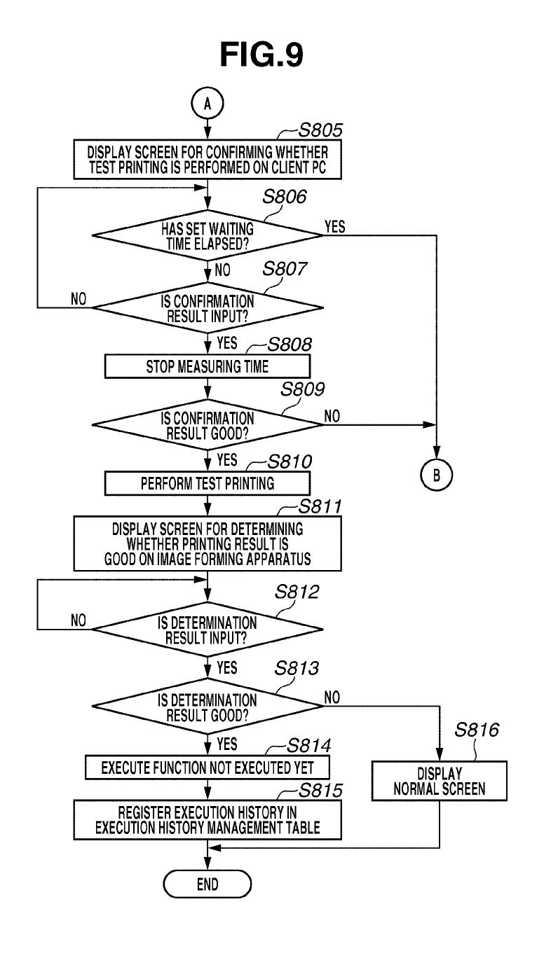

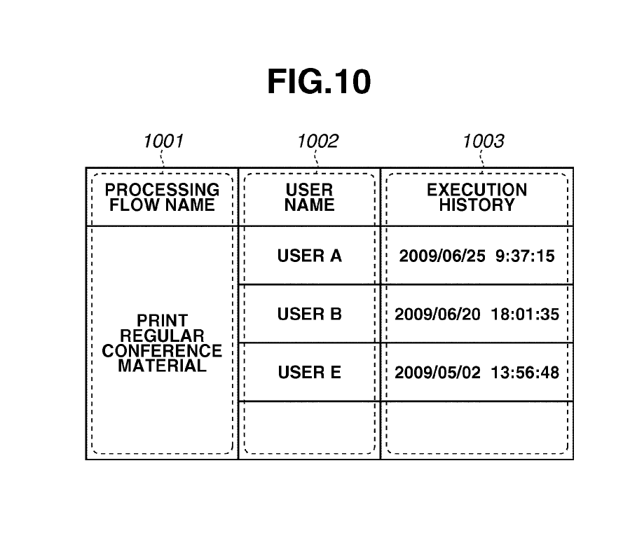

For convenience sake, a processing flow execution history management table (execution history registration means) is described with reference to FIG. 10. The processing flow execution history management table is used in the processes for remotely executing the event driven processing flow illustrated in flowcharts in FIGS. 8 and 9.

As illustrated in FIG. 10, the processing flow execution history management table includes three data items (columns), i.e., a processing flow name 1001, a user name 1002, and an execution date 1003. The processing flow execution history management table is generated for each set event driven processing flow. Therefore, a name of the event driven processing flow corresponding to the processing flow execution history management table is registered in the processing flow name 1001.

Every time the event driven processing flow is driven, a name of a user who has generated a drive event for driving the event driven processing flow is registered in the user name 1002. When execution of all functions in the event driven processing flow driven by the user is terminated, the date on which the execution is terminated is registered in the execution date 1003.

When the setting of the event driven processing flow is changed, all registered contents in the user name 1002 and the execution date 1003 are deleted. When the event driven processing flow is deleted, a processing flow execution history management table corresponding thereto is also deleted.

Processes for executing an event driven processing flow by a remote operation will be described below with reference to flowcharts in FIGS. 8 and 9. When the multifunction peripheral 101 is started and an application program according to the flowcharts in FIGS. 8 and 9 is started, the processing proceeds to step S801. In step S801, the CPU 201 starts a task for each event driven processing flow set as a drive event to monitor whether an event occurs. If the event set as the drive event occurs (YES in step S801), the processing proceeds to step S802. In step S802, the CPU 201 determines whether the event driven processing flow relating to the event includes a process for printing a plurality of copies.

If the process for printing a plurality of copies is not included (NO in step S802), the processing proceeds to step S822. In step S822, the CPU 201 executes all functions (processes) set as the event driven processing flow for the event that has occurred (third processing flow execution means). In step S823, the CPU 201 registers an execution history of the event driven processing flow that has been executed in step S822 (user name 1002 and execution date 1003) in the processing flow execution history management table. Then, the processes for executing the event driven processing flow end.

On the other hand, if the process for printing a plurality of copies is included (YES in step S802), the processing proceeds to step S803. In step S803, the CPU 201 starts to measure time for monitoring whether an execution waiting time set in the event driven processing flow elapses. In step S804, the CPU 201 then determines whether the execution history of the event driven processing flow (user name 1002, and execution date 1003) associated with a user who has generated the event has already been registered in the processing flow execution history management table.

If the execution history associated with the user who has generated the event has not been registered yet in the processing flow execution history management table (NO in step S804), i.e., if the user attempts to first execute the event driven processing flow, the processing proceeds to step S805. In step S805, the CPU 201 displays an operation screen (not illustrated) for the user to select whether trial printing is performed on the computer 105 via a network I/F 210.

In step S806, the CPU 201 then determines whether the execution waiting time set in the event driven processing flow has elapsed. If the execution waiting time has elapsed (YES in step S806), the processing proceeds to step S822. In step S822, the CPU 201 executes all functions (processes) set as the event driven processing flow for the event that has occurred.

If the execution waiting time has not been elapsed yet (NO in step S806), the processing proceeds to step S807. In step S807, the CPU 201 determines whether a result of confirmation (selection) whether trial printing is performed is obtained. If the confirmation result is not obtained (NO in step S807), the processing returns to step S806. If the confirmation result is obtained (YES in step S807), the processing proceeds to step S808. In step S808, the CPU 201 stops measuring time for monitoring passage of the execution waiting time set in the event driven processing flow.

In step S809, the CPU 201 determines whether the confirmation result is “good”. If the confirmation result is “good” (YES in step S809), the processing proceeds to step S810. In step S810, the CPU 201 performs trial printing after executing an input function and an editing function which are set as the event driven processing flow for the event that has occurred. In step S811, the CPU 201 then displays an operation screen for requesting the user to determine whether a copy of a print product obtained by the trial printing is “good” on the touch panel of the operation unit 212.

In step S812, the CPU 201 determines whether a determination result about the copy of the print product is input from the operation screen. If the determination result is input from the operation screen (YES in step S812), the processing proceeds to step S813. In step S813, the CPU 201 determines whether the determination result is “good”. If the determination result is “good” (YES in step S813), the processing proceeds to step S814. In step S814, the CPU 201 prints the remaining copies and executes a box function, a sending function, or the like for the other set box.

In step S815, the CPU 201 then registers an execution history of the event driven processing flow that has been executed in step S814 (user name 1002, and execution date 1003) in the processing flow execution history management table. The processes for executing the event driven processing flow end. If the determination result of the copy of the print product obtained by trial printing is not “good” (NO in step S813), the processing proceeds to step S816. In step S816, the CPU 201 displays a normal screen of the multifunction peripheral 101 on the touch panel of the operation unit 212 without performing the processes in steps S814 and S815.

If the CPU 201 determines that the execution history has already been registered in the processing flow execution history management table (YES in step S804), the processing proceeds to step S817. In step S817, the CPU 201 displays on the computer 105 an operation screen for the user to select whether all the processes in the event driven processing flow set for an event as a processing target are executed immediately without waiting until the execution waiting time elapses.

In step S818, the CPU 201 then determines whether the execution waiting time set in the event driven processing flow has elapsed. If the execution waiting time has elapsed (YES in step S818), the processing proceeds to step S822. In step S822, the CPU 201 executes all the functions set as the event driven processing flow for the event that has occurred. If the execution waiting time has not elapsed yet (NO in step S818), the processing proceeds to step S819. In step S819, the CPU 201 determines whether a result of confirmation (selection) whether all the functions are immediately executed is obtained.

If the confirmation result is not obtained (NO in step S819), the processing returns to step S818. If the confirmation result is obtained (YES in step S819), the processing proceeds to step S820. In step S820, the CPU 201 determines whether the confirmation result is that all the functions are immediately executed. If the confirmation result is that all the functions are immediately executed (YES in step S820), the processing proceeds to step S822. In step S822, the CPU 201 executes all the functions set as the event driven processing flow for the event that has occurred (second processing flow execution means).

If the confirmation result is not that all the functions are immediately executed (NO in step S820), the processing proceeds to step S821. In step S821, the CPU 201 determines whether the execution waiting time set in the event driven processing flow has elapsed. If the execution waiting time has elapsed (YES in step S821), the processing proceeds to step S822. In step S822, the CPU 201 executes all the functions.

In the second exemplary embodiment, the trial printing can be also performed in an remote operation, so that the print product unintended by the user can be prevented from being printed in large amounts without damaging the advantage of the event driven processing flow.

The present invention is not limited to the first and second exemplary embodiments. For example, technical thoughts of the first and second exemplary embodiments can be applied to an image forming apparatus such as a scanner, a copying machine, and a printer other than the multifunction peripheral on the assumption that they have a plurality of functions, for example.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-297680 filed Dec. 28, 2009, which is hereby incorporated by reference herein in its entirety.

What is claimed is:

1. An image forming apparatus comprising:
a processing flow setting unit configured to combine a plurality of processes using a plurality of functions included in the image forming apparatus to set the processes as a series of processing flow;
an event setting unit configured to set an event for driving the processing flow set by the processing flow setting unit;
a waiting time setting unit configured to set a waiting time that elapses after the event set by the event setting unit occurred until the processing flow set for the event is executed;
a reception unit configured to receive an instruction to execute a part of the processes in the processing flow set for the event on trial; and
a processing flow execution unit configured to execute the processing flow,
wherein, if the reception unit receives the instruction to execute a part of the processes in the processing flow on trial from after the event set by the event setting unit occurred and before the waiting time elapses, the processing flow execution unit executes a part of the processes in the processing flow on trial, and executes the processing flow if the waiting time has elapsed without the reception unit receiving the instruction to execute a part of the processes in the processing flow after the event set by the event setting unit occurred.

2. The image forming apparatus according to claim 1, further comprising:
an execution history registration unit configured to associate an execution history of the processing flow set by the processing flow setting unit with a user and register the execution history;
a determination unit configured to determine, if the event set by the event setting unit occurs in response to an instruction from the user, whether the execution history registration unit registers the execution history which is associated with the user of the processing flow set for the event; and
a first selection unit configured to select, if the determination unit determines that the execution history is not registered, whether the processing flow execution unit executes the processing flow on trial according to the instruction from the user who has generated the event,
wherein the processing flow execution unit executes a part of the processes in the processing flow on trial if the first selection unit selects to execute the processing flow on trial.

3. The image forming apparatus according to claim 2, further comprising:
a second selection unit configured to select, if the determination unit determines that the execution history is registered, whether the processing flow set for the event to be a determination target of the determination unit is executed without waiting until the waiting time elapses according to the instruction from the user who has generated the event,
wherein the processing flow execution unit executes, if the second selection unit selects to execute the processing flow without waiting until the waiting time elapses, the processing flow without waiting until the waiting time elapses.

4. The image processing apparatus according to claim 1, wherein the processing flow execution unit executes, if the event set by the event setting unit occurs and if the processing flow set for the event does not include a process relating to a printing function, the processing flow without executing a part of the processes in the processing flow on trial.

5. The image processing apparatus according to claim 1, further comprising:
a request unit configured to request, after the processing flow execution unit executes a part of the processes in the processing flow, a user who has generated the event for executing the processing flow to determine whether an execution result of the part of the processes in the processing flow is right or wrong,
wherein the processing flow execution unit executes the processes other than the part of the processes in the processing flow if the user determines that the execution result is right in response to the request by the request unit.

6. A method for controlling an image forming apparatus, comprising:
combining a plurality of processes using a plurality of functions included in the image forming apparatus to set the processes as a series of processing flow;
setting an event for driving the set processing flow;
setting a waiting time that elapses after the set event occurred until the processing flow set for the event is executed; and
executing a part of the processes in the processing flow on trial if an instruction to execute apart of the processes in the processing flow on trial is received from after the set event occurred and before the waiting time elapses, and executing the processing flow if the waiting time has elapsed without receiving the instruction to execute a part of the processes in the processing flow on trial after the set event occurred.

7. A computer readable non-transitory storage medium storing a program for executing a control method according to claim 6.
